(19) United States
(12) Patent Application Publication
(10) Pub. No.: US 2013/0006860 A1
(43) Pub. Date: Jan. 3, 2013

(54) ANTICIPATORY PAYMENT AUTHORIZATION

(75) Inventors: Girish Balasubramanian, Fremont, CA (US); Marc E. Elbirt, Pleasanton, CA (US)

(73) Assignee: EBAY INC., SAN JOSE, CA (US)

(21) Appl. No.: 13/538,515

(22) Filed: Jun. 29, 2012

Related U.S. Application Data
(60) Provisional application No. 61/502,958, filed on Jun. 30, 2011.

(51) Int. Cl. G06Q 20/40

(52) U.S. Cl. 705/44

(57) ABSTRACT

A payment provider anticipates when a user will be making a payment and authorizes a payment amount to a merchant or payee prior to a total purchase amount being determined. When the user is ready to pay, the merchant can complete the transaction without further communication with the payment provider, thereby speeding up the checkout or payment process.

### CROSS REFERENCE TO RELATED APPLICATION

The present application claims priority to U.S. Provisional Patent Application Ser. No. 61/502,958, filed Jun. 30, 2011.

### BACKGROUND

1. Field of the Invention

The present invention generally relates to financial transactions, and in particular, to payment authorizations.

2. Related Art

In a typical financial transaction involving a payment provider, a request is made to the payment provider to authorize a payment or a money transfer. The request is made by a payee, such as a merchant, seller, or recipient, or by a payer, such as a consumer, purchaser, or sender, when the payment is ready to be made. This can be after all items have been scanned or selected for purchase or a payment amount determined, so that there is a specific total amount available to give to the payment provider for authorization. The payment provider then processes the payment request and returns an authorization, a decline, or other notification.

However, the processing can take time, resulting in the consumer having to wait to finalize the purchase. Therefore, a need exists to provide a quicker payment process for the consumer using a payment provider service.

### SUMMARY

According to one embodiment, a payment provider anticipates when a user will be making a payment and authorizes a payment amount to a merchant or payee prior to a total purchase amount being determined. When the user is ready to pay, the merchant can complete the transaction without further communication with the payment provider, thereby speeding up the checkout or payment process.

In one embodiment, the payment provider first recognizes when a user is shopping or about to start a checkout process using cookies, mobile-based location detection technology, or other suitable means, including the user informing the payment provider directly through a user device, such as a mobile phone, PC, tablet, or other computing device. The payment provider receives information about the user and the merchant. Using this information, the payment provider determines an amount to pre-approve. The amount may be based on average purchase amount at the merchant, the user's spending habits, the location of the user, average purchase amount for the user, recent purchase history, balance in or credit available for the user account, balance or credit available in user funding sources for the user account, etc.

Once an amount is determined, the payment provider transmits a pre-authorization for that amount to the merchant. In one embodiment, the pre-authorization is through a token, where the token has an expiration time. The token may have an expiration time and other limitations/restrictions.

When the user is ready to pay, if the total amount is not greater than the pre-authorized amount and the token has not expired (or any other limitations/restrictions violated), the merchant can complete the transaction without any further requests to the payment provider. As a result, the user is able to complete a payment or checkout as soon as the total is available.

These and other features and advantages of the present invention will be more readily apparent from the detailed description of the embodiments set forth below taken in conjunction with the accompanying drawings.

### BRIEF DESCRIPTION OF THE FIGURES

FIG. 1 is a flowchart showing a process a payment provider performs for pre-authorizing a payment amount according to one embodiment;

FIG. 2 is a block diagram of a networked system suitable for implementing the process of FIG. 1 according to an embodiment; and

FIG. 3 is a block diagram of a computer system suitable for implementing one or more components in FIG. 2 according to one embodiment of the present disclosure,

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

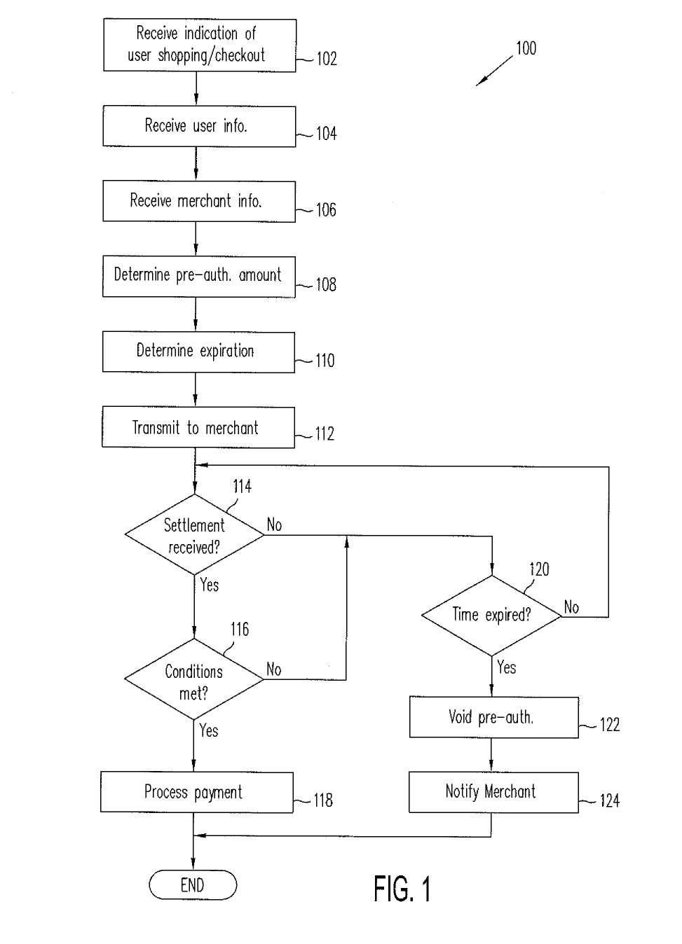

FIG. 1 is a flowchart showing a process 100 a payment provider performs for an anticipatory authorization, according to one embodiment. At step 102, the payment provider, such as PayPal, Inc. of San Jose, Calif., receives information or an indication that a user may be shopping, finished shopping, ready to begin a checkout process, or in a checkout process. The information may be received through a user device, such as a mobile phone, PC, tablet, laptop, or other computing device. The user may be shopping online or at a physical location, such as a store. With online shopping, the indication may be received when the user places an item in a cart, begins a search process on the shopping site, actively selects a link or button to let the payment provider that the user wants a pre-authorization process to begin, etc. With a physical location, the indication may be received when the user access an app on the user's mobile device, selects a button or link to let the payment provider know the user wants a pre-authorization process to start, the logs into a payment site or app, the user is in a known shopping location, such as a store, etc.

Next, at step 104, the payment provider receives user information. This may be received during the indication of step 102 or separately, such as when the user access the payment site through the user's mobile device, PC, or other computing device, including logging into the user's account, which can be before or after step 102. User information may include a user identifier, such as a phone number of the user's mobile device, an email address, a user name, a user device ID, or other such identifier that enables the payment provider to locate and access a user account associated with the identifier. User information may also include authenticating information, such as a password or PIN, associated with a user account with the payment provider.

The payment provider also receives merchant information at step 106, which may be during step 102, step 104, or separately (before or after). Merchant information may include the merchant's identity, location, contact information, identifier, account information with the payment provider, and any other relevant information. The information may be received directly from the merchant or indirectly, such as when the payment provider detects the user is at a merchant location and determines the merchant information based on the user location. Merchant information may be received directly from an onsite merchant signal or from a merchant site when the user is on the merchant site.

Based on the information received, the payment provider determines a pre-authorization amount, at step 108, for the user with the merchant. This may be based on numerous factors. For example, the payment provider may look at the user's history of payments for this merchant, similar merchants, or all merchants, the user's recent payment or shopping history with this merchant, similar merchants, or all merchant, the type of or name of the merchant (e.g., higher end merchants typically will have a higher checkout total), the user's spending habits recently and historically, whether the purchase is online or at a physical location, purchase data at an online site or a physical location, the user's payment history to the payment provider, a user rating with the payment provider, the amount of time the user has been using the payment provider account, etc.

Other information may include the balance or credit available in the user account or with funding sources associated with the user account and the day the anticipatory authorization is being made as compared with days or periods in which the user typically spends more money than average, such as holidays, birthdays, anniversaries, etc. Also, non-periodic events or purchasing opportunities may also be used, such as a birth of a new baby. Some more examples of factors include any sales or incentives currently being offered by the merchant, such that the user may be apt to spend more during this sale, especially if the sale includes items of interest to the user, based on past purchases and/or wish list items accessible by the payment provider.

These and other factors may result in a pre-authorization amount ranging from $0 (pre-authorization not given) to hundreds or even thousands of dollars. For example, if the user is at an electronics store, the user has a history of large purchases at the store, the user has not purchased much recently, the user has an excellent payment history with the payment provider, the merchant has a sale on televisions, and the user has been searching for televisions or has a television on his wish list, the pre-authorization amount may be a large number, such as $3000.

The payment provider may, at step 110, also determine a time limit for the pre-authorization. One or more of the same factors can be used to determine the time limit

Additional factors include where in the checkout process the user is, how long the user typically takes to start and finish a checkout online or at a physical location, how long the merchant or store typically takes to finish a checkout during this particular time, day, or period, whether there is a sale happening at the store (which could result in longer checkout times), etc. For example, if a user is at a grocery store on a Sunday night and has scanned the first item, where the user typically buys a lot of groceries for the following week at the store on Sunday nights (a typical busy time for the store), the pre-authorization time limit may be 10 minutes, which would be longer than if the user were starting a checkout process on an online site or on another time/day at the store. In other embodiments, the time limit may also default to a certain number for the user or even have no time limit.

Next, the payment provider transmits the pre-authorization to the merchant at step 112. In one embodiment, a token is sent to the merchant, which includes the pre-authorization amount and any other information, such as an expiration time or other limitations/restrictions. Typically, the merchant receives the pre-authorization before the user is ready to pay, e.g., before any items have been entered by the merchant or when additional items are still being scanned or added to a cart. In one embodiment, the merchant knows the pre-authorization amount and expiration, such as the information being displayed on a merchant device. In another embodiment, the merchant does not see this information, but the information is available on a merchant device to use after the total amount has been determined.

When all items have been scanned/entered, a total amount due is provided. In conventional means, the user may then present payment, such as cash, credit card, debit card, or a check. With a credit card, debit card, or other payment card, information associated with the card must be processed with the total amount due to determine whether the payment can be approved. This may take a while, leaving the user waiting for the processing to complete.

In some cases, a user swipes a payment card during the checkout process so that the card information is already received. However, there will still be a delay because the card authorization process cannot be completed until the payment amount is known. As such, the user may still need to wait for processing after the total amount is known.

In one embodiment of the present disclosure, once the total amount due is known, the merchant can quickly determine, either by visually comparing the total with the pre-authorized amount or having a merchant system automatically compare, whether that amount is less than or equal to the pre-authorization amount and whether the pre-authorization has expired (again “manually” or automatically by the merchant system). If the amount due is within the pre-authorization amount and the pre-authorization has not expired, the merchant approves the transaction, and the user completes the payment process without having to wait for an authorization process to finish. In one embodiment, the merchant approves the payment and settles with the payment provider at a later time, e.g., after the user has left or at the end of the day. In another embodiment, the merchant settles with the payment provider as soon as the total amount due is obtained. The expiration time for the pre-authorization may be based on when the transaction is completed (e.g., when the amount is totaled) or when the merchant transmits a settlement request to the payment provider. If the latter, the merchant may need to be sure there is sufficient time on the pre-authorization for the merchant to settle the payment with the payment provider.

In one embodiment, the payment provider determines, at step 114, whether a settlement request or call is received, such as transmitted by the merchant when or after the purchase is complete. If a settlement request is received, a determination is made, at step 116, whether conditions for the pre-authorization have been met. This may include determining whether the actual amount is within the pre-authorization amount and whether the pre-authorization has not expired or had not yet expired at the time the actual amount was obtained. Other conditions may also be analyzed, based on any conditions associated with the specific pre-authorization, conditions for the user's general pre-authorization account, and/or conditions imposed by the payment provider.

If conditions are met, the payment is processed at step 118. Processing, in one embodiment, includes crediting a merchant account and debiting the user's account with the corresponding amounts. Processing may also include voiding the pre-authorization, which prevents another use before the expiration period, and notifying the merchant and/or user.

Referring back to step 114, if no redemption is received, the payment provider determines, at step 120, whether the pre-authorization has expired. Expiration may be automatically determined by the payment provider when the current time/day passes the expiration time/day of the pre-authorization. If the pre-authorization has expired without its use, the pre-authorization is voided at step 122, such that the pre-authorization is not longer available for use. The merchant may be then notified, at step 124, of the expired pre-authorization. This lets the merchant know that the pre-authorization is no longer valid and that if the user wishes to pay for the transaction, normal payment procedures will need to be performed, such as authorization of a credit card, check, or debit card.

Note that more than one pre-authorization can be made during a single user transaction with a merchant. For example, the merchant may be sent a first pre-authorization request based on a first set of information. However, the payment provider may receive additional information during the transaction (i.e., before a total amount owed is determined), that changes the first pre-authorization. In an example, during a transaction, the payment provider may notice high price items being scanned, a lot of items being scanned, an excessive amount of time used during the checkout process, and other information that may indicate a higher pre-authorization amount and/or a longer expiration period to replace or supplement the first pre-authorization. A subsequent pre-authorization may also shorten the expiration period and/or reduce the amount based on changed information. Thus, the payment provider may continually process information to determine whether an existing pre-authorization should be revised to better reflect the transaction.

One or more of the steps or actions described above may be omitted, combined, and/or performed in a different sequence as desired and appropriate.

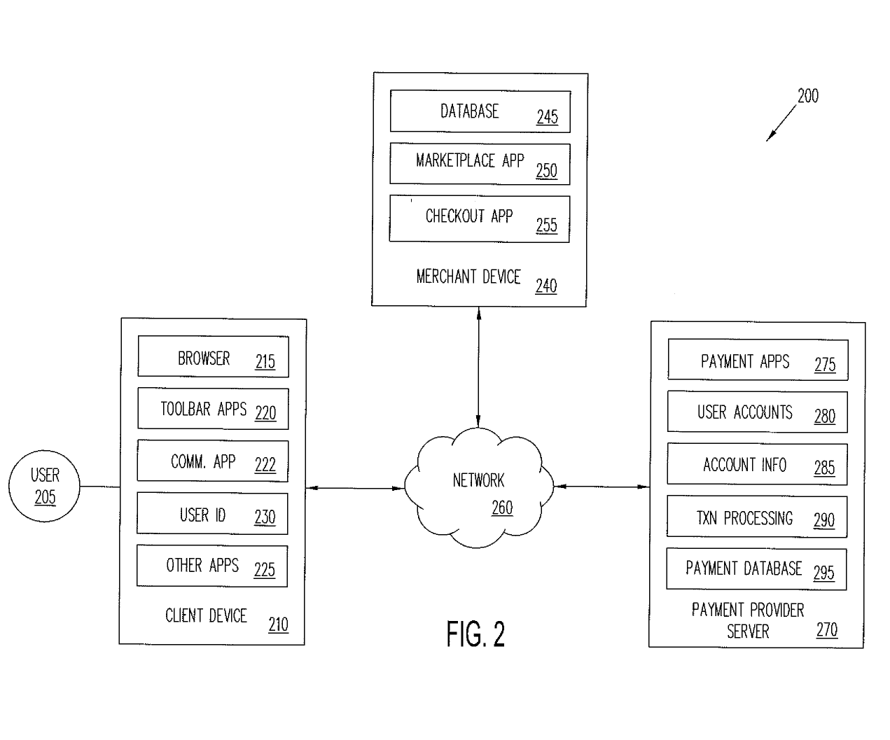

FIG. 2 is a block diagram of a networked system 200 configured to handle a financial transaction between a payment recipient (e.g., merchant) and a payment sender (e.g., user or consumer), such as described above, in accordance with an embodiment of the invention. System 200 includes a user device 210, a merchant server 240, and a payment provider server 270 in communication over a network 260. Payment provider server 270 may be maintained by a payment provider, such as PayPal, Inc. of San Jose, Calif. A user 205, such as the sender or consumer, utilizes user device 210 to perform a payment transaction with merchant server 240 using payment provider server 270 or to convey a desire to make a payment to the payment provider so that the payment provider may issue an anticipatory or pre-authorization to the merchant on behalf of the user.

User device 210, merchant server 240, and payment provider server 270 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 200, and/or accessible over network 260.

Network 260 may be implemented as a single network or a combination of multiple networks. For example, in various embodiments, network 260 may include the Internet or one or more intranets, landline networks, wireless networks, and/or other appropriate types of networks.

User device 210 may be implemented using any appropriate hardware and software configured for wired and/or wireless communication over network 260. For example, in one embodiment, the user device may be implemented as a computing tablet, personal computer (PC), a smart phone, personal digital assistant (PDA), laptop computer, and/or other types of computing devices capable of transmitting and/or receiving data.

User device 210 may include one or more browser applications 215 which may be used, for example, to provide a convenient interface to permit user 205 to browse information available over network 260. For example, in one embodiment, browser application 215 may be implemented as a web browser configured to view information available over the Internet. User device 210 may also include one or more toolbar applications 220 which may be used, for example, to provide client-side processing for performing desired tasks in response to operations selected by user 205. In one embodiment, toolbar application 220 may display a user interface in connection with browser application 215 as further described herein.

User device 210 may further include other applications 225 as may be desired in particular embodiments to provide desired features to user device 210. For example, other applications 225 may include security applications for implementing client-side security features, programmatic client applications for interfacing with appropriate application programming interfaces (APIs) over network 260, or other types of applications. Applications 225 may also include email, texting, voice and IM applications that allow user 205 to send and receive emails, calls, and texts through network 260, as well as applications that enable the user to communicate, place orders, and make payments through the payment provider as discussed above. User device 210 includes one or more user identifiers 230 which may be implemented, for example, as operating system registry entries, cookies associated with browser application 215, identifiers associated with hardware of user device 210, or other appropriate identifiers, such as used for payment/user/device authentication. In one embodiment, user identifier 230 may be used by a payment service provider to associate user 205 with a particular account maintained by the payment provider as further described herein. A communications application 222, with associated interfaces, enables user device 310 to communicate within system 200.

Merchant server 240 may be maintained, for example, by a merchant or seller offering various products and/or services in exchange for payment to be received over network 260. Generally, merchant server 240 may be maintained by anyone or any entity that receives money, which includes charities as well as retailers and restaurants. Merchant server 240 includes a database 245 identifying available products and/or services (e.g., collectively referred to as items) which may be made available for viewing and purchase by user 205, including receipts associated with identifiers, such as barcodes. Accordingly, merchant server 240 also includes a marketplace application 250 which may be configured to serve information over network 260 to browser 215 of user device 210. In one embodiment, user 205 may interact with marketplace application 250 through browser applications over network 260 in order to view various products, food items, or services identified in database 245.

Merchant server 240 also includes a checkout application 255 which may be configured to facilitate the purchase by user 205 of goods or services identified by marketplace application 250. Checkout application 255 may be configured to accept payment information from or on behalf of user 205 through payment service provider server 270 over network 260. For example, checkout application 255 may receive and process a payment confirmation or pre-authorization from payment service provider server 270, as well as transmit transaction information to the payment provider and receive information from the payment provider (e.g., a preauthorization). Checkout application 255 may also be configured to accept one or more different funding sources for payment, as well as create an invoice or receipt of the transaction.

Payment provider server 270 may be maintained, for example, by an online payment service provider which may provide payment between user 205 and the operator of merchant server 240. In this regard, payment provider server 270 includes one or more payment applications 275 which may be configured to interact with user device 210 and/or merchant server 240 over network 260 to facilitate the purchase of goods or services by user 205 of first user device 210 at a merchant POS or site as discussed above.

Payment provider server 270 also maintains a plurality of user accounts 280, each of which may include account information 285 associated with individual users. For example, account information 285 may include private financial information of users of devices such as account numbers, passwords, device identifiers, user names, phone numbers, credit card information, bank information, or other financial information or funding source information which may be used to facilitate online transactions by user 205. Advantageously, payment application 275 may be configured to interact with merchant server 240 on behalf of user 205 during a transaction with checkout application 255 to track and manage purchases made by users and which funding sources are used.

A transaction processing application 290, which may be part of payment application 275 or separate, may be configured to receive information from a user device and/or merchant server 240 for processing and storage in a payment database 295. Transaction processing application 290 may include one or more applications to process information from user 205 for processing an order and payment at a merchant POS as described herein. As such, transaction processing application 290 may store details of an order associated with a pre-authorization for individual users. Payment application 275 may be further configured to determine the existence of and to manage accounts for user 205, as well as create new accounts if necessary.

Payment database 295 may store transaction details from completed transactions, including pre-authorization details and/or details of the transaction. Such information may also be stored in a third party database accessible by the payment provider and/or the merchant. User payment history may also be stored in payment database 295 or in user accounts 280 or account information 285. User search history, wish list information, and different merchant information (as described herein) may be stored in user accounts 280 or account information 285.

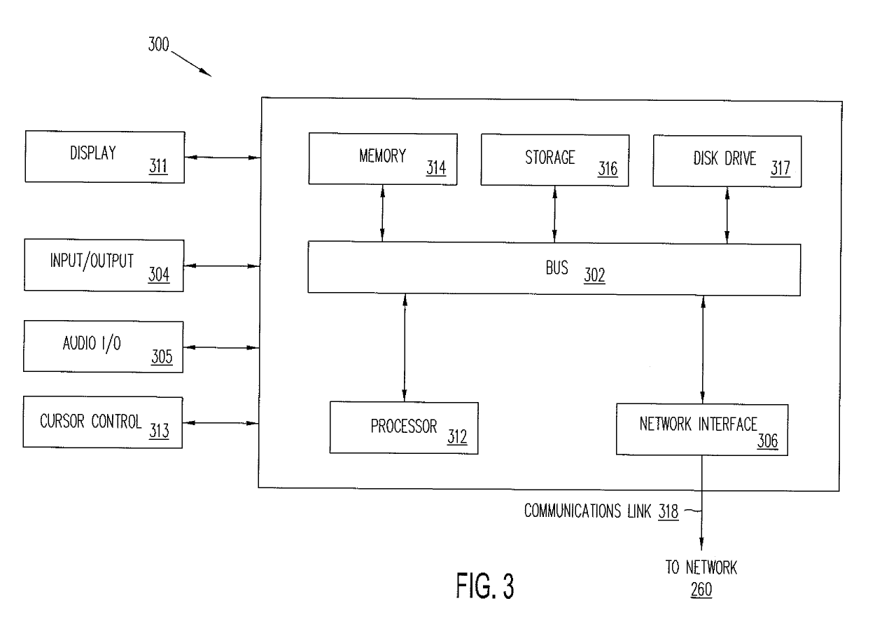

FIG. 3 is a block diagram of a computer system 300 suitable for implementing one or more embodiments of the present disclosure. In various implementations, the user device may comprise a personal computing device (e.g., a personal computer, laptop, smart phone, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 300 in a manner as follows.

Computer system 300 includes a bus 302 or other communication mechanism for communicating information data, signals, and information between various components of computer system 300. Components include an input/output (I/O) component 304 that processes a user action, such as selecting keys from a keypad/keyboard, selecting one or more buttons or links, etc., and sends a corresponding signal to bus 302. I/O component 304 may also include an output component, such as a display 311 and a cursor control 313 (such as a keyboard, keypad, mouse, etc.). An optional audio input/output component 305 may also be included to allow a user to use voice for inputting information by converting audio signals. Audio I/O component 305 may allow the user to hear audio. A transceiver or network interface 306 transmits and receives signals between computer system 300 and other devices, such as another user device, a merchant server, or a payment provider server via network 360. In one embodiment, the transmission is wireless, although other transmission mediums and methods may also be suitable. A processor 312, which can be a micro-controller, digital signal processor (DSP), or other processing component, processes these various signals, such as for display on computer system 300 or transmission to other devices via a communication link 318. Processor 312 may also control transmission of information, such as cookies or IP addresses, to other devices.

Components of computer system 300 also include a system memory component 314 (e.g., RAM), a static storage component 316 (e.g., ROM), and/or a disk drive 317. Computer system 300 performs specific operations by processor 312 and other components by executing one or more sequences of instructions contained in system memory component 314. Logic may be encoded in a computer readable medium, which may refer to any medium that participates in providing instructions to processor 312 for execution. Such a medium may take many forms, including but not limited to, non-volatile media, volatile media, and transmission media. In various implementations, non-volatile media includes optical or magnetic disks, volatile media includes dynamic memory, such as system memory component 314, and transmission media includes coaxial cables, copper wire, and fiber optics, including wires that comprise bus 302. In one embodiment, the logic is encoded in non-transitory computer readable medium.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 300. In various other embodiments of the present disclosure, a plurality of computer systems 300 coupled by communication link 318 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system for facilitating a financial transaction over a network, comprising:
a memory storing user account information, wherein the information comprises a passphrase corresponding to a user account; and
one or more processors in communication with the memory adapted to:
receive, by a payment provider, an indication of a desire for a user to pay a seller using an account with the payment provider before a total payment amount is determined;
receive information about the user and seller;
process the information about at least one of the user and the seller;
generate a pre-authorization based on the information, wherein the pre-authorization includes a maximum authorized payment amount; and
transmit the pre-authorization to the seller before the total payment is determined.

2. The system of claim 1, wherein the one or more processors further receives a settlement from the seller.

3. The system of claim 1, wherein the pre-authorization includes an expiration.

4. The system of claim 1, wherein the one or more processors generates a second pre-authorization during the financial transaction based on information about the financial transaction and before the total payment is determined.

5. The system of claim 4, wherein the one or more processors transmits the second pre-authorization to the seller during the financial transaction and before the total payment is determined.

6. The system of claim 3, wherein the pre-authorization is voided when the expiration has passed.

7. The system of claim 6, wherein the seller is notified when the pre-authorization is voided.

8. The method of claim 1, wherein the one or more processors further determine whether conditions of the pre-authorization have been met.

9. A non-transitory machine-readable medium comprising a plurality of machine-readable instructions which when executed by one or more processors of a server are adapted to cause the server to perform a method comprising:
receiving, by a payment provider, an indication of a desire for a user to pay a seller using an account with the payment provider before a total payment amount is determined;
receiving information about the user and seller;
processing the information about at least one of the user and the seller;
generating a pre-authorization based on the information, wherein the pre-authorization includes a maximum authorized payment amount; and
transmitting the pre-authorization to the seller before the total payment is determined.

10. The non-transitory machine-readable medium of claim 9, wherein the method further comprises receiving a settlement from the seller.

11. The non-transitory machine-readable medium of claim 9, wherein the pre-authorization includes an expiration.

12. The non-transitory machine-readable medium of claim 8, wherein the method further comprises generating a second pre-authorization during the financial transaction based on information about the financial transaction and before the total payment is determined.

13. The non-transitory machine-readable medium of claim 12, wherein the method further comprises transmitting the second pre-authorization to the seller during the financial transaction and before the total payment is determined.

14. The non-transitory machine-readable medium of claim 11, wherein the pre-authorization is voided when the expiration has passed.

15. The non-transitory machine-readable medium of claim 14, wherein the seller is notified when the pre-authorization is voided.

16. The non-transitory machine-readable medium of claim 9, wherein the one or more processors further determine whether conditions of the pre-authorization have been met.

17. A method, comprising:
receiving, electronically by a hardware processor of a payment provider, an indication of a desire for a user to pay a seller using an account with the payment provider before a total payment amount is determined;
receiving, electronically by the payment provider, information about the user and seller;
processing, electronically by the hardware processor, the information about at least one of the user and the seller;
generating, electronically by the payment provider, a pre-authorization based on the information, wherein the pre-authorization includes a maximum authorized payment amount; and
transmitting, electronically by the hardware processor, the pre-authorization to the seller before the total payment is determined.

18. The method of claim 17, wherein the pre-authorization includes an expiration.

19. The method of claim 17, further comprising generating a second pre-authorization during the financial transaction based on information about the financial transaction and before the total payment is determined.

20. The method of claim 19, further comprising transmitting the second pre-authorization to the seller during the financial transaction and before the total payment is determined.
